(19) United States
(12) Patent Application Publication
(10) Pub. No.: US 2009/0292882 A1
(43) Pub. Date: Nov. 26, 2009

(54) STORAGE AREA NETWORK SERVER WITH PARALLEL PROCESSING CACHE AND ACCESS METHOD THEREOF

(75) Inventors: Sheng Li, Tianjin (CN); Tom Chen, Taipei (TW); Win-Harn Liu, Taipei (TW)

Correspondence Address: Workman Nydegger;1000 Eagle Gate Tower, 60 East South Temple, Salt Lake City, UT, 84111, US

(73) Assignee: INVENTEC CORPORATION, Taipei (TW)

(21) Appl. No.: 12/126,591

(22) Filed: May 23, 2008

(51) Int. Cl. G06F 12/08

(52) U.S. Cl. 711/141; 711/E12.017

(57) ABSTRACT

A storage area network (SAN) server with a parallel processing cache and an access method thereof are described, which are supplied for a plurality of request to access data in a server through an SAN. The server includes physical storage devices, for storing data sent by the request and data transmitted to the request; copy managers, for managing the physical storage devices connected to the server, and each copy manager includes a cache memory unit, for temporarily storing the data accessed by the physical storage devices, and a data manager, for recording an index of the data in the cache memory unit, providing a cache copy stored in the cache memory unit to a corresponding request end, and confirming an access time for each virtual device manager to access the cache copy.

### BACKGROUND OF THE INVENTION

1. Field of the Invention

The present invention relates to a storage area network (SAN) server and an access method thereof. More particularly, the present invention relates to an SAN server with a parallel processing cache and an access method thereof.

2. Related Art

When constructing internal storage networks, enterprises generally select to combine direct access storage (referred to as DAS), network attached storage (referred to as NAS), and storage area network (referred to as SAN) with one another for storing data.

The SAN separates many storage devices from a local network to form another network, and it is characterized in achieving many-to-many high-speed connection between servers and physical storage devices. SAN generally adopts fibre channel to be connected to the server, in which, particularly, a fibre channel card (FC HBA) is installed in the server; then, a fibre exchanger is connected; and finally, the physical storage devices are connected.

The SAN data transmission adopts block levels in the manner of centralized management. The data is stored in logic unit number (referred to as LUN), and the access of the data is controlled by a lock manager. If the data is required to be accessed, the file only can be accessed through the server. In this way, it can avoid the situation that the same file is read and written at the same time, and thus reducing files having different versions.

In order to improve the speed of reading the file data from the server, a cache may be used in the server to reduce the frequency of reading and writing to the physical storage devices. The cache memory stores a part of the file data in the physical storage devices, which is referred to as a cache copy. Although the cache memory has a small configuration size, the access speed thereof is quite high. Referring to FIG. 1, it is a flow chart of reading and writing a cache memory. A request end sends a request for accessing data to the server (Step S110). The cache memory is searched whether to have a corresponding cache copy therein or not (Step S120). Then, it is determined whether the cache memory has the cache copy stored therein or not (Step S130). If the cache memory has the cache copy stored therein, the cache copy is read out from the cache memory to the request end (Step S131). If the cache memory does not have the cache copy stored therein, the server searches the data from the physical storage devices (Step S132).

As the access speed of the cache memory is much higher than that of the physical storage devices, the searching speed is improved. However, the above cache mode can merely provide a single data request. If different request send an access request for the same data, the server can quickly provide the cache copy to each request end, but it cannot determine the write sequence of the data for each request end, and thus the data overwrite problem occurs in the server. In this way, the server cannot effectively utilize the cache technology to improve the access speed to the physical storage devices.

### SUMMARY OF THE INVENTION

In view of the above problems, the present invention is directed to an SAN server with a parallel processing cache, which is provided for a plurality of request to access data in a server through the SAN.

In order to achieve the above objective, the present invention provides an SAN server with a parallel processing cache, which includes: physical storage devices, an assign manager, copy managers, a cache memory unit, and a data manager. The physical storage devices are used to store data sent by the request and data transmitted to the request for being read by the request. The assign manager assigns access requests of the request to the corresponding physical storage devices. The copy managers are used to manage the physical storage devices connected to the server. Each copy manager further includes a cache memory unit and a data manager. The cache memory unit temporarily stores data accessed by the physical storage devices. The data manager records an index of the data in the cache memory unit, provides a cache copy stored in the cache memory unit to a corresponding request end, and confirms an access time for a virtual device manager to access the cache copy.

On the other aspect, the present invention is directed to an access method of a parallel processing cache, which is provided for a plurality of request to access data in a server through an SAN.

In order to achieve the above objective, the present invention provides an access method of a parallel processing cache, which includes the following steps: setting copy managers in a server, in which each copy manager further includes a cache memory; searching data in a plurality of connected physical storage devices through the copy managers; storing the searched data as a plurality of cache data into the cache memory unit; and synchronizing the transacted cache data into the cache memory unit with each corresponding virtual device manager stored therein.

The present invention provides an SAN server with a parallel processing cache and an access method thereof. A plurality of copy managers is set in the server and each copy manager has an independent cache memory. The present invention provides the cache data assignment between copy managers and the write management of the cache copy accessed by each request end. Accordingly, the server can provide the corresponding cache data to each request end, and the cache data are not overwritten.

### BRIEF DESCRIPTION OF THE DRAWINGS

The present invention will become more fully understood from the detailed description given herein below for illustration only, which thus is not limitative of the present invention, and wherein:

FIG. 1 is a flow chart of reading and writing a cache memory in the conventional art;

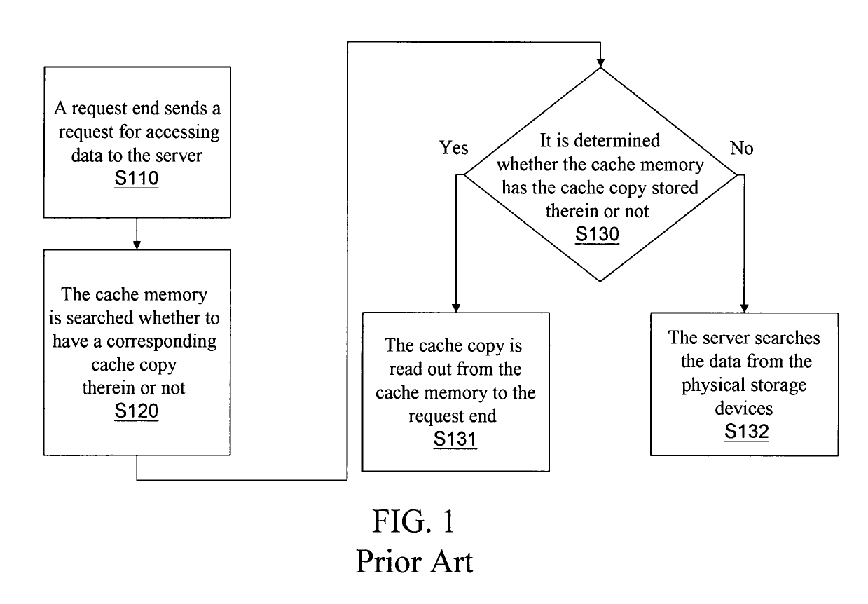

FIG. 2 is a schematic view of an architecture of the present invention;

FIG. 3 is a flow chart of operations of the present invention;

FIG. 4 is a flow chart of sending a read only request to a copy manager;

FIG. 5a is a flow chart of a copy manager sending out a write request to another copy manager; and

FIG. 5b is a flow chart of a copy manager sending out a write request to another copy manager.

### DETAILED DESCRIPTION OF THE INVENTION

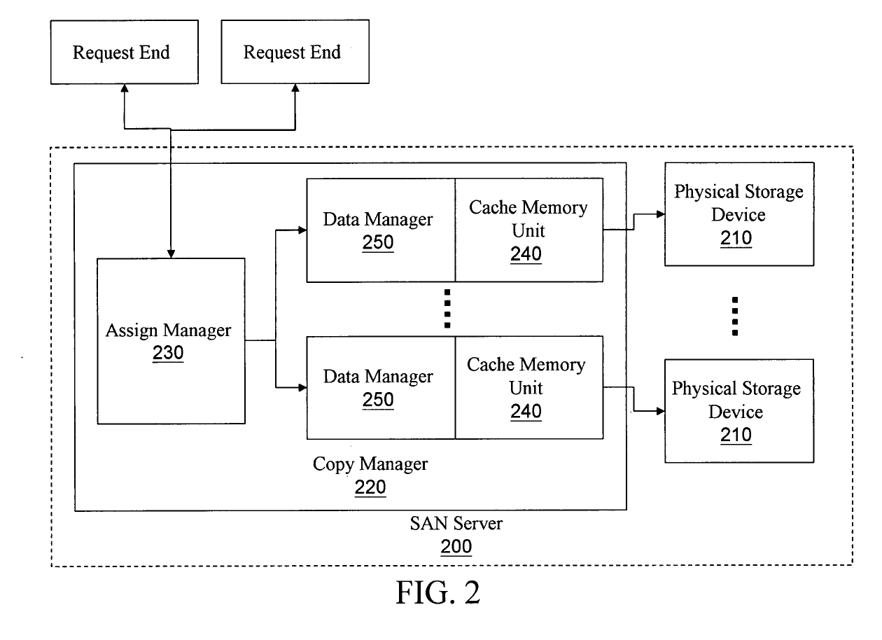

Referring to FIG. 2, it is a schematic view of an architecture of the present invention. An SAN server 200 with a parallel processing cache (hereinafter, referred to as SAN server) includes: physical storage devices 210 and copy managers 220. Each copy manager 220 further includes: an assign manager 230, a cache memory unit 240, and a data manager 250.

The physical storage devices 210 are used to store data sent by the request and data transmitted to the request for being read by the request. The copy managers 220 manage the physical storage devices 210 connected to the SAN server 200. The physical storage devices 210 further include a cache access record used to record the access frequency of the data stored in the physical storage devices 210 and the corresponding storage address thereof.

The assign manager 230 assigns the access requests of the request to the corresponding physical storage devices 210 or data managers 250. The cache memory unit 240 temporarily stores the data accessed by the physical storage devices 210. The data manager 250 records an index of the data in the cache memory unit 240 and provides a cache copy stored in the cache memory unit 240 to a corresponding request end. The index serves as a response message for searching. For example, if a corresponding data is searched in the cache memory unit 240, the searching times are recorded in the index. If no corresponding data is searched in the cache memory unit 240, the index is set as −1 to indicate that the cache memory unit 240 is not hit.

The cache copy is the data stored in the cache memory unit 240. Furthermore, the data manager 250 is also used to confirm the access time for each virtual device manager to access the cache copy.

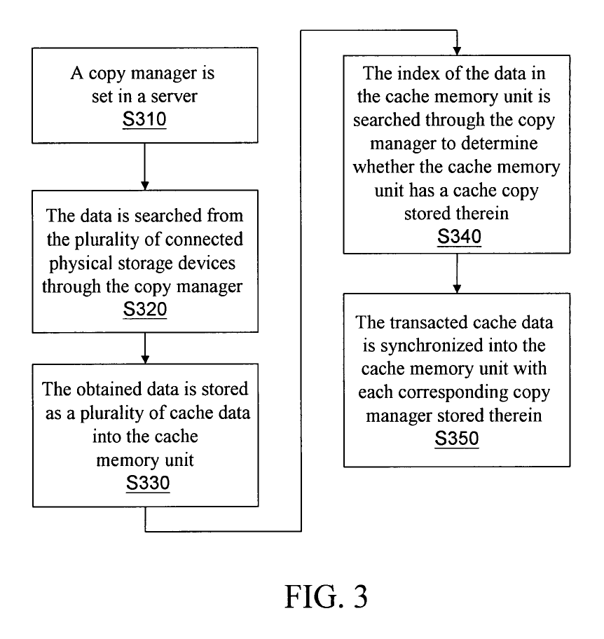

Referring to FIG. 3, it is a flow chart of operations of the present invention. The process flow of the present invention includes the following steps. Firstly, a plurality of copy managers is set in a server (Step S310), and each copy manager 220 further includes a cache memory unit. Next, the data is searched from the plurality of connected physical storage devices through the copy manager (Step S320).

Then, the obtained data is stored as a plurality of cache data into the cache memory unit (Step S330). The index of the data in the cache memory unit is searched through the copy manager to determine whether the cache memory unit has a cache copy stored therein (Step S340), in which the assign manager 230 assigns a copy manager 220. The transacted cache data is synchronized into the cache memory unit 240 with each corresponding copy manager 220 stored therein through a cache mapping process.

If the data to be searched is not hit in the memory unit, the corresponding data is searched from the cache memory unit 240 in other copy managers 220. If the data to be searched is not hit in the cache memory unit 240 in other copy managers 220, the corresponding data is searched from the physical storage devices 210. Accordingly, the access times to the physical storage device 210 are reduced. Finally, the transacted cache data is synchronized into the cache memory unit with each corresponding copy manager stored therein (Step S350).

In order to illustrate the process flow of the present invention more clearly, in this embodiment, the data manager 250 controls the data access in the form of the following cache memory storage format, which is shown in Table 1.

TABLE 1
Cache memory storage format

| | | | | |
|---|---|---|---|---|
| Index | Data Address | Data Size | Operate | Valid Flag |

The item of Operate indicates a corresponding operation of accessing the data in the cache memory address. Valid Flag indicates whether the data in the cache memory address is valid or not. For example, if one data block in the physical storage device 210 is updated, but the data in the cache memory of a corresponding copy manager 220 is not updated, the data in the data block of the physical storage device 210 is invalid. Referring to Table 2, the cache access record format is shown.

TABLE 2
Cache access record format

| | | | | |
|---|---|---|---|---|
| Index | Copy Manager | Data Address | Data | Locked |
| | Label | | Size | |

The label of the copy manager 220 indicates the copy manager 220 that has a cache copy of the data to be accessed stored therein. The locked flag indicates whether the data block to be accessed is read or written by the copy manager 220. Herein, for example, a write/read request is sent to the copy manager 220.

a. Send a Read Only Request to the Copy Manager

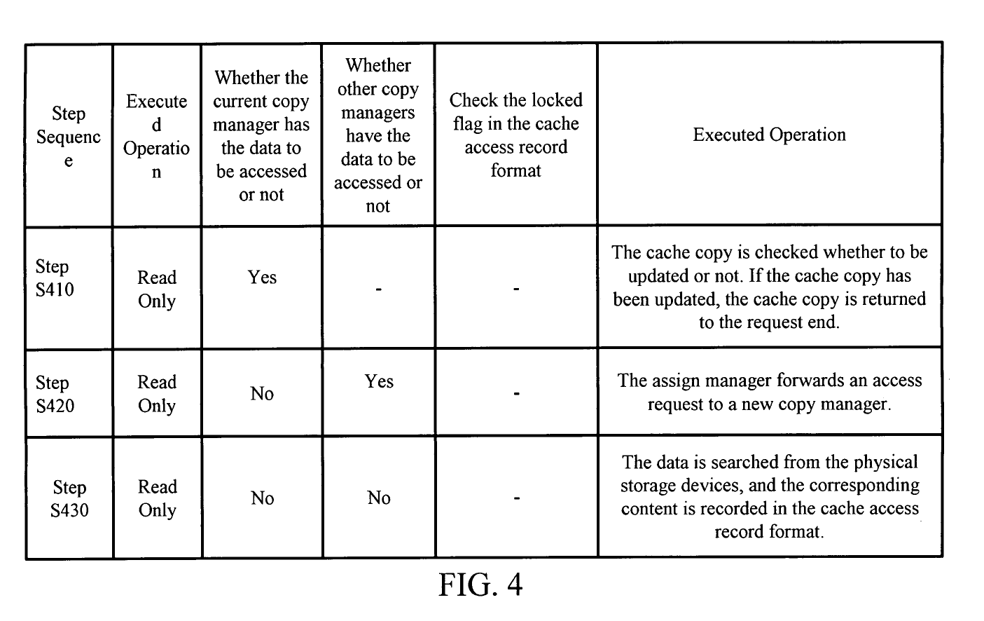

Referring to FIG. 4, it is flow chart of sending a read only request to a copy manager. First, the assign manager 230 assigns a copy manager. It is searched whether the cache memory unit 240 of the assigned copy manager 220 has the data to be accessed stored therein. If the corresponding cache copy is obtained, the cache copy is checked whether to be updated or not. If the cache copy has been updated, the cache copy is returned to the request end (Step S410). If no corresponding cache copy is obtained, the cache memory units 240 of other copy managers 220 are searched whether to have the data to be accessed stored therein.

If the data is obtained in the cache memory units 240 of other copy managers 220, the assign manager 230 forwards an access request to the new copy manager 220 (Step S420). If the data is not obtained in the cache memory units 240 of other copy managers 220, the data is searched from the physical storage devices 210 (Step S430), and the corresponding content is recorded in the cache access record format.

b. Send a Write Request to the Copy Manager

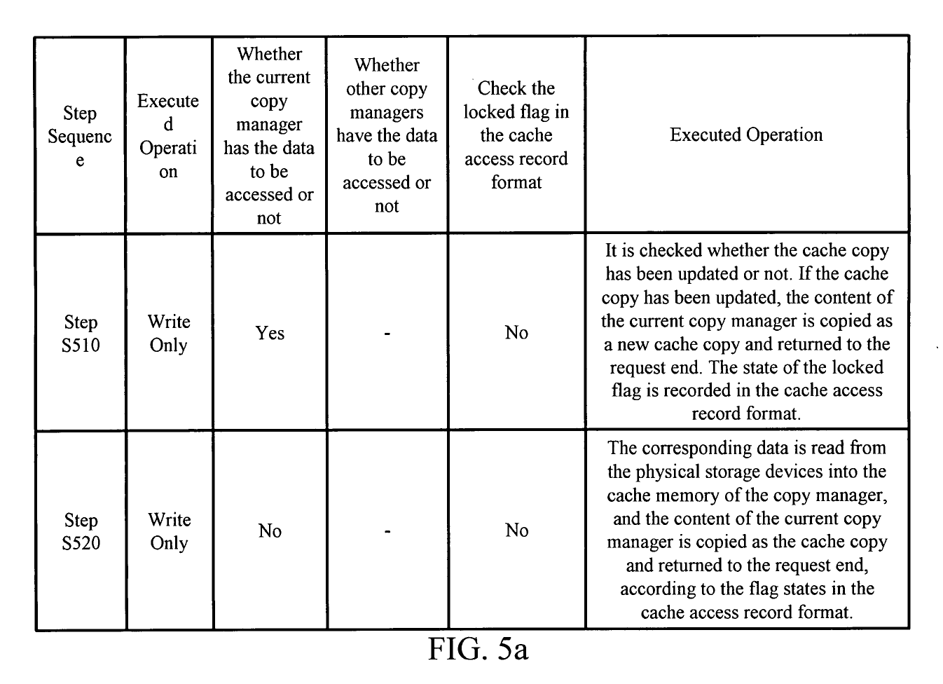

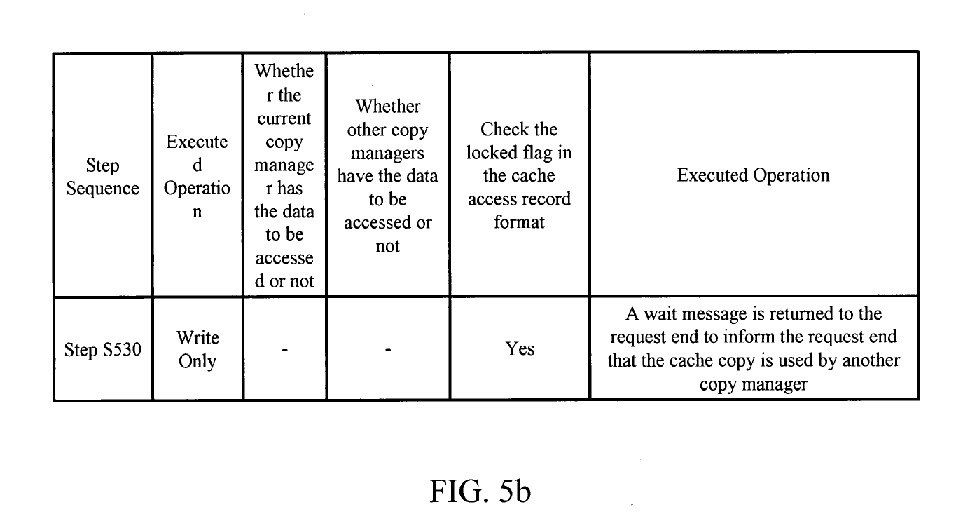

Referring to FIGS. 5a and 5b, they are respectively flow charts of a copy manager sending out a write request to another copy manager.

It is searched whether the cache memory unit 240 of the assigned copy manager 220 has the data to be accessed stored therein, and then checked whether the state of the locked flag in the cache access record format is true or not. If the locked flag is false, it is checked whether the cache copy has been updated or not. If the cache copy has been updated, the content of the current copy manager 220 is copied as a new cache copy and returned to the request end. The state of the locked flag is recorded in the cache access record format (Step S510).

If the data cannot be obtained in any copy manager 220, it is searched from the physical storage devices 210. The state of the locked flag in the cache record format is checked to confirm whether the data is also requested by another request end. If the locked flag is false, the corresponding data is read from the physical storage devices 210 into the cache memory of the copy manager 220. According to the flag states in the cache access record format, the content of the current copy manager 220 is copied as the cache copy and returned to the request end (Step S520). If the locked flag is true, a wait message is returned to the request end to inform the request end that the cache copy is used by another copy manager 220 (Step S530).

The present invention provides an SAN server with a parallel processing cache and an access method thereof, in which a plurality of copy managers 220 is set in the server, and an individual cache memory is provided in each copy manager 220. Therefore, the present invention provides cache data assignation between the copy managers 220 and write management of the cache copy accessed by each request end, such that the server can provide the corresponding cache data for each request end, and each cache data is prevented from being overwritten.

What is claimed is:

1. A storage area network (SAN) server with a parallel processing cache, provided for a plurality of request to access data in a server through an SAN, comprising:
a plurality of physical storage devices, for storing data sent by the request and data transmitted to the request for being read by the request; and
a plurality of copy managers, for managing the physical storage devices connected to the server, wherein each copy manager further comprises:
an assign manager, for assigning accessing requests of the request to the corresponding physical storage devices;
a cache memory unit, for temporarily storing the data accessed by the physical storage devices; and
a data manager, for recording an index of the data in the cache memory unit, providing a cache copy stored in the cache memory unit to a corresponding request end, and confirming an access time for each virtual device manager to access the cache copy.

2. The SAN server with a parallel processing cache as claimed in claim 1, wherein the physical storage device further comprises a cache access record, for recording an access frequency of a data stored in the physical storage device and a corresponding storage address thereof.

3. The SAN server with a parallel processing cache as claimed in claim 1, further comprises a data synchronization means further retrieves the cache copy from other virtual device managers.

4. An access method of a parallel processing cache, provided for a plurality of request to access data in a server through an SAN, comprising:
setting a copy manager in a server, wherein the copy manager further comprises a cache memory unit for temporarily storing data accessed by physical storage devices;
searching data in the plurality of connected physical storage devices through the copy manager;
storing the obtained data as a plurality of cache data into the cache memory unit; and
synchronizing transacted cache data into the cache memory unit with each corresponding copy manager stored therein.

5. The access method of a parallel processing cache as claimed in claim 4, wherein searching the data in the physical storage devices further comprises:
searching an index of the data in the cache memory unit through the copy manager, so as to determine whether the cache memory unit comprises the cache copy or not.

6. The access method of a parallel processing cache as claimed in claim 4, wherein the transacted cache data is synchronized to the cache memory unit with each corresponding copy manager stored therein through a cache mapping process.

7. The access method of a parallel processing cache as claimed in claim 4, wherein the step of searching the data further comprises:
if the data to be searched is not hit in the memory unit, searching the corresponding data from the cache memory units in other copy managers; and
if the data to be searched is not hit in the cache memory units of other copy managers, searching the corresponding data from the physical storage devices.
